(19) United States
(12) Patent Application Publication
(10) Pub. No.: US 2006/0034185 A1
(43) Pub. Date: Feb. 16, 2006

(54) Systems and methods for monitoring and evaluating a connectivity device

(76) Inventors: Till Immanuel Patzschke, Wiesbaden (DE); Darren Leroy Wesemann, North Salt Lake, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/176,838

(22) Filed: Jul. 7, 2005

Related U.S. Application Data
(60) Provisional application No. 60/586,426, filed on Jul. 8, 2004.

(51) Int. Cl. H04L 12/26

(52) U.S. Cl. 370/252

(57) ABSTRACT

The end-to-end services provided to an end-user by a service provider in a communications network can be tested by a system including a testing agent embedded within a connectivity device and a receiving server for receiving and analyzing test data from the connectivity device. The testing agent performs one or more tests to simulate a user's activities and obtain data regarding the simulated activities, for example simulating a user's activities by proactively consuming and measuring the end-to-end performance of services provided by the service provider. The receiving server may include a data storage device configured for receiving and storing test data from the testing agent and an expert engine configured for analyzing the test data and providing a predictive analysis.

### CROSS-REFERENCE TO RELATED APPLICATIONS

This application claims the benefit of U.S. Provisional Patent Application No. 60/586,426, filed Jul. 8, 2004, which is incorporated herein by reference in its entirety.

### BACKGROUND OF THE INVENTION

1. The Field of the Invention

The present invention relates to systems and methods for monitoring a connectivity device. More particularly, the present invention relates to systems and methods for collecting and evaluating data from agents deployed on multiple connectivity devices such as cellular telephones, set-top boxes, cable modems, and the like.

2. The Relevant Technology

Consumers today often have access to many services through various types of networks. Cable networks, satellite networks, cellular networks, and computer networks such as the Internet are examples of networks through which various types of services are provided. In fact, the services available through these types of networks are often provided to thousands of consumers.

When a user purchases a service from a service provider, the service provider has an interest in insuring that the user receives an accessible and quality product. One way to achieve these goals is to perform testing to insure that their servers or other equipment can serve a substantial number of users without crashing or otherwise failing. This type of testing is often referred to as load testing and is typically performed using simulations in a laboratory environment. U.S. patent application Ser. No. 10/049,867, which claims priority to PCT Application Serial No. PCT/EP00/06509 (with related publication no. WO 01/11822 and an international filing date of Jul. 10, 2000) discloses systems and methods for load testing of networks and network components. The foregoing patent applications and publication are incorporated herein by reference.

A laboratory environment permits a service provider to enact various scenarios to determine whether a particular service can be delivered over a network. A load balancing test, for example, helps determine how well the servers can withstand a large number of requests. This type of test is not usually performed in the a live network because of the possibility of crashing a network or failing various connectivity components. It is one thing to crash a laboratory network and quite another to deprive customers of the services they have purchased.

While such a test can provide information about the ability of a server (or server system) to handle many requests, the test does not sufficiently reflect an actual user experience. In fact, testing a network or the availability of services over a network from a user's perspective presents additional problems that are not readily addressed in a testing laboratory. It is difficult, for example, to test network connectivity and access to the ISP. It is also difficult to evaluate the quality of the services actually delivered to the end users. Service providers are also unable to monitor services such as, for example, voice over IP, bandwidth-on-demand, video-on-demand, and the like in a laboratory environment. In other words, it is very hard to measure or monitor what a user actually experiences in a laboratory environment.

Observing data sent to or received from an end user at a location that is remote to the user can provide some insight to the user experience, but much of the data cannot be accurately interpreted because the actions of the user are not known. The idea of monitoring each device of each end user is usually discarded because of the seeming difficulties. The large number of user devices typically discourages attempts to monitor each device because of issues associated with data transmission, data collection, and interaction. Thus, it is very difficult to obtain information from each user's device.

### BRIEF SUMMARY OF THE INVENTION

The present invention relates to systems and methods for testing the services provided to end-users to obtain data from the user's devices. Advantageously, embodiments of the present invention are from the perspective of the end user using an agent that is embedded in the end user's device. The agent provides visibility into the quality of the user's experience and can accurately measure the services provided the end user. A receiving server connected to the network collects test data from the agent and may perform an expert analysis on the test data to provide a predictive analysis.

More particularly, preferred embodiments of the invention provide proactive measurement of a user's experience across a network by accurately replicating real user activities. For example, embodiments of the inventions can detect customer experience issues by proactively consuming and measuring the end-to-end performance of services provided by a service provider so the service provider can analyze a user's simulated actual experience. The systems and methods of the invention are scalable and extensible in that they can gather, store, and learn from literally millions of agents installed on connectivity devices to generate an accurate picture of the services or devices.

Accordingly, a first example embodiment of the invention is a method for testing the quality of service provided to a user by a service provider within a communications network. The method generally includes: providing an agent on a connectivity device of a user; causing the agent to perform one or more tests involving the connectivity between a network device and the connectivity device; collecting data from the one or more tests, wherein the data is indicative of an aspect of a user experience; and transmitting the collected data to a receiving server using at least one scalable protocol.

A second example embodiment of the invention is a system for testing the services provided to an end-user by a service provider in a communications network. The system generally includes: a testing agent embedded within a connectivity device associated with a user, wherein the connectivity device is in communication with a network administered by a service provider and the testing agent performs one or more tests in order to simulate a user's activities and obtain data regarding the simulated activities; and a receiving server in communication with the network administered by the service provider, the receiving server comprising a data storage device configured for receiving and storing test data from the testing agent.

Yet another example embodiment of the invention is another system for testing the services provided to an end-user by a service provider in a communications network. The system generally includes: a testing agent embedded within a connectivity device associated with a user, wherein the connectivity device is in communication with a network administered by a service provider and the testing agent performs one or more tests in order to simulate a user's activities by proactively consuming and measuring the end-to-end performance of services provided by the service provider; and a receiving server in communication with the network administered by the service provider, the receiving server comprising: a data storage device configured for receiving and storing test data from the testing agent; and an expert engine configured for analyzing the test data and providing a predictive analysis.

In addition, another example embodiment uses the agent to perform tests on the connectivity device itself or on user applications that are run by the connectivity device but not controlled by a service provider. This allows a service provider to understand the quality of performance provided by applications and devices that may be outside its control. For example the performance of an email program, device operating system, or web browser can be tested with various metrics to determine how well it is performing at various tasks.

These and other objects and features of the present invention will become more fully apparent from the following description and appended claims, or may be learned by the practice of the invention as set forth hereinafter.

### BRIEF DESCRIPTION OF THE DRAWINGS

To further clarify the advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary environment for implementing embodiments of the present invention;

FIG. 2 illustrates embodiments of agents that monitor connectivity devices, and transmit data regarding a user experience; and

FIG. 3 illustrates features of a preferred receiving server according to another embodiment of the invention.

### DETAILED DESCRIPTION OF THE PREFERRED EMBODIMENTS

In the following description, numerous specific details are set forth in order to provide a thorough understanding of the present invention. It will be obvious, however, to one skilled in the art that the present invention may be practiced without these specific details. In other instances, well-known aspects of networks, service providers, protocols, and the like have not been described in particular detail in order to avoid unnecessarily obscuring the present invention.

The present invention relates to systems and methods for testing the services provided to an end-user. Testing the services provided to an end user can include, but is not limited to: proactive measurement of a user's experience across a network by accurately replicating real user activities, monitoring the services provided to the end user, measuring various metrics or parameters related to the connectivity device of the end user, and the like. Advantageously, embodiments of the present invention occur from the perspective of the end user using an agent that is embedded in the device of the end user. The agent provides visibility into the accuracy of the user's experience and can accurately measure the services provided the end user.

For example, embodiments of the inventions can detect customer experience issues by proactively consuming and measuring the end-to-end performance of services provided by a service provider before the user does, raising an alarm when service thresholds have been exceeded or service quality is low. By embedding a testing agent within a user's actual connectivity device, the systems and methods of the invention allow for an accurate understanding of a connectivity device's actual performance for a user. By performing the tests when the connectivity device is not in use by a user, the tests avoid slowing the user's actual experience. Embodiments can also provide tools to understand how real users interact with a service provider's network. In addition, the systems and methods of the invention are scalable and extensible in that they can gather, store, and learn from literally millions of Agents installed on connectivity devices.

Embodiments of the invention can therefore monitor, test and/or measure the services or connections of multiple devices. The agents embedded in the devices of the end users can generate data or network activity that closely mirrors actual user experiences or data or network activity that monitors an actual user experience. Agents are deployed in each consumer premise equipment (CPE) device and each agent may perform tests that at least copy the actions of end users. To accurately measure the service provided to an end user, the tests may be related to a service level agreement of the user. Agents are not limited, however, to performing tests or taking measurements that are related to an end user's service level agreement, but can also perform other tests or measurements. One benefit of configuring an agent to perform actions that correspond with a particular service level agreement is that the agent can provide data that can be used to evaluate the quality of the services delivered to the end user.

More specifically, an agent embedded in a user's device enables service providers to ensure the quality of the services received through the user devices. Testing a service from the perspective of an end user provides data that may enable the problem to be resolved more quickly. When a user purchases a service and is not receiving that service, for example, the user may only recognize that the service is unavailable or is of poor quality. The user is not necessarily interested in why the service failed or is of poor quality. The user is also not typically aware of where the problem is occurring. As previously mentioned, monitoring the user's connection at a location remote from the user does not accurately reflect the user's experience and may make it more difficult to identify the problem with the user's service. Embodiments of the invention, however, proactively measure the performance or quality of a service from the user's perspective and provide a service context from the end user's perspective.

Embodiments of the invention also identify service quality degradation. In fact, service performance can be measured before the service is accessed by an end user because the agent is enabled to perform actions that a user may perform. The measurements provided by the agent can be incorporated into system management for the service provider. In other words, the quality of a service can be measured before the service is assured to the user. The information collected from the devices (or agents) of the end users can be used to improve service, etc.

In one example, an agent is deployed in a user's connectivity device. Examples of connectivity devices include set-top boxes, cellular telephones, cable modems, and the like or any combination thereof. The agents embedded in the connectivity devices can be adapted to the service level agreement of the end user or have access to the service level agreement of the end user. With this information, the agent can simulate user activity to measure the quality or performance of the service(s) being provided to the end user, including voice over IP, bandwidth-on-demand, video-on-demand, video conferencing, and the like. The agent can also measure or gauge the network connectivity and/or access to an ISP. The data collected by the agent reflects the experience of a real end user because the tests or measurements are being performed from the connectivity device of the end user.

In other words, the agent is on the edge of the network with an end-user. The agent can therefore test the quality of the services, etc., by performing actions that the end-user would ordinarily perform. In addition, the agent can be configured to perform other types of tests as well. The data from these tests is collected and transmitted for storing and analysis. Performing test from the edge of a network provides context to the data that is collected by the agents.

Examples of protocols that can be tested for the different types of services and networks include access protocols such as: ATM (Asynchronous Transfer Mode), PPoEoA (Point-to-Point Protocol over Ethernet over ATM), PPPoA (Point-to-Point Protocol over ATM), PPPoE (Point-to-Point Protocol over Ethernet), PPPoEoA (Point-to-Point Protocol over Ethernet Over ATM), 1×RTT, and GPRS; network protocols such as: DHCP (Dynamic Host Configuration Protocol) and IP; application protocols such as HTTP (HyperText Transport Protocol), FTP (File Transfer Protocol), SMTP (Simple Mail Transfer Protocol), POP3 (Post Office Protocol 3), Logon/Logoff, Ping, RTSP (Real Time Streaming Protocol), Telnet, and NNTP (Network News Transfer Protocol).

In addition, the testing agent can be configured to perform tests on the connectivity device itself or on user applications that are run by the connectivity device but not controlled by a service provider. This allows a service provider to understand the quality of performance provided by applications and devices that may be outside its control. For example the performance of an email program, device operating system, or web browser can be tested with various metrics to determine how well it is performing at various tasks.

The raw test information, or low level metrics, obtained from individual tests are collected at each agent and used to generate more useful high level metrics that predict a user's quality of experience and help a service provider troubleshoot. By way of example only, examples of low level metrics that can be determined from tests for the HTTP protocol include: start time for the HTTP request, the total time for a response after an HTTP request, header retrieval time, content retrieval time, error breakdown, and other metrics known in the art or readily apparent to those skilled in the art in view of the disclosure herein that are indicative of the quality and length of a task over a network. Similarly, low level metrics can be determined for other protocols under test.

In another aspect of the invention, the agent can be configured so that a user can activate a test sequence. This is desirable when a user is having a bad quality experience and wants to make the service provider aware of it. The test systems can then, at the user's request, perform the desired tests and report the results of the test so that a use can know that a particular bad experience has been logged. Particularly for mobile devices, but also for stationary devices, it is preferable that the test data indicate the location of the connectivity device.

Reference will now be made to the figures wherein like structures will be provided with like reference designations. It is understood that the drawings are diagrammatic and schematic representations of presently preferred embodiments of the invention, and are not limiting of the present invention nor are they necessarily drawn to scale.

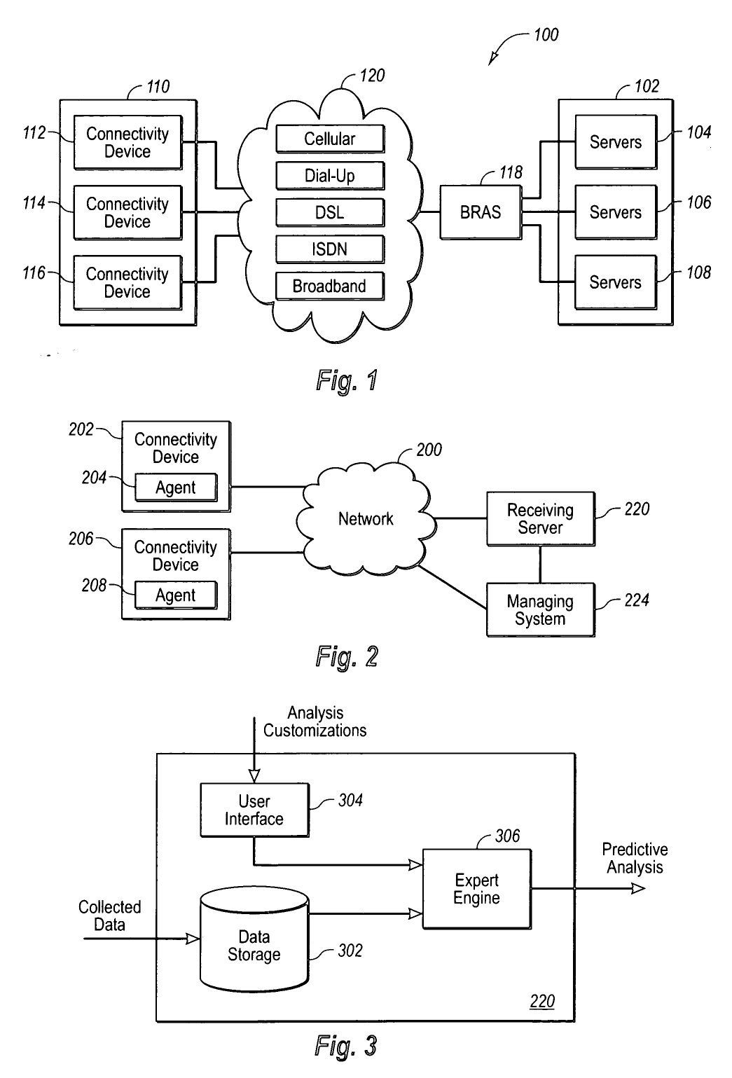

FIG. 1 illustrates an example of an environment for implementing embodiments of the present invention. FIG. 1 illustrates a broadband access server (BRAS) 118 that is used in this example by the connectivity devices 110 to access the service providers 102. In one embodiment, one of the service providers may provide the network or infrastructure while another service provider may provide a service using the network. Thus, agreements may be present between different service providers.

The connectivity devices 110 include various devices 112, 114, and 116. Each device can represent a different device such as, for example, a set-top box, a cable modem, a telephone, a cellular telephone, a personal digital assistant, a computer, other connectivity devices, and the like or any combination thereof. The service providers 102 includes servers 104, 106, and 108 that provide the services included in the service level agreements associated with each device 112, 114, and 116.

The network 120 represents various types of network connections that include, but are not limited to: cellular, dial-up, DSL, ISDN, broadband networks, fiber optic networks, and the like or any combination thereof. Embodiments of the agent embedded in each device test, measure and/or monitor a user experience by, for example: testing network connectivity and access to an ISP; testing the quality of services delivered to end users; monitoring service level agreements for bandwidth-on-demand; and monitoring network access to content servers, application servers, etc.

FIG. 2 illustrates an agent that tests (monitors, measures, etc.) a user experience. FIG. 2 illustrates devices 202, 206 that are connected with a network 200. An agent or “virtual user” is loaded on each device 202, 206. Thus, the agent 204 is associated with the device 202 and the agent 208 is associated with the device 206. Each agent may be, for example, stored in flash memory and can be updated as needed over the same networks 200 being measured and/or monitored by the agent. One advantage of the agent 208 is that the agent 208 is on the edge of the network. Therefore, the experience of the agent 208 is likely to be the same as the experience of the user. The tests performed by the agent 208 have the same context as actions performed by an end user.

An agent, such as the agent 208, is configured to perform tests on the services that are available to a consumer through the device 206. In other words, the agent 208 performs many of the same tasks that the user is expected to perform under the terms of a service level agreement. The agent 208, however, is not limited to the service level agreement but can perform other types of measurements or tests as well.

The agent 208 may perform the tests at times when the user is not using the device 206. Alternatively, the agent 208 has the ability to monitor the use of the device 206. By performing actions that a user is expected to perform under a service level agreement, the agent 208 can anticipate or detect problems the user may experience. Thus, the agent 208 enables the quality of the service to be assured. The agent 208, for example, can test the network connectivity and/or access to an ISP. The agent 208 can test the quality of the services delivered to the end user. The agent 208 can also monitor service level agreements and network access to content servers, application servers, and the like.

Embodiments of the invention enable the agents to report or collect the data resulting from the various tests or measurements. Embodiments of the invention also enable all of the deployed agents to be managed. When hundreds of thousands of agents are deployed, as previously stated, the collection and transmission of data becomes difficult. If each device has a reporting agent, then hundreds of thousands of agents are generating data that needs to be transmitted and/or analyzed. Embodiments of the present invention include systems and methods for transmitting data from the agents, collecting the information from the agents, and interacting with the agents.

The agents can be addressed or controlled in groups, or individually. Alternatively, each agent may have a profile that can be used to control the transmission and/or collection of data. Thus, the timing of when the agents transmit data can be controlled. Agents may transmit data at off-peak transmission times to minimize the load on the network. The reporting times of agents may also be staggered.

The transmission of the data is also performed, in one embodiment, using a messaging protocol such as SMTP (email). SMTP is scalable and can handle a large amount of data. In fact, transmitting data from multiple agents deployed on connectivity devices using SMTP takes advantage of the capabilities of existing networks and therefore reduces the likelihood of causing a failure in the network. Embodiments of the invention are not limited to SMTP, however, but can communicate using other protocols as well. The transmission may also depend on the type of device in which the agent is resident. For example, if the agent is a cellular telephone, then SMS, GPRS, or other scalable protocols may be used to transmit the data.

In other words, existing networks have demonstrated the ability to handle a large number of transmissions using SMTP without problems. The agents described herein can therefore report results using SMTP. This enables a large number of deployed agents to transmit data that represents the experiences of a large number of end users. The data from the agents can be received by a server 220 (or a server system) and stored in a database. The messages can also be parsed and processed before being stored.

Because the agents may transmit data using SMTP, the receiving server 220 may include a mail server. In addition, the server 220 provides an interface that can be accessible by a managing system 224 of a service provider. In one embodiment, the interface is related to the service provider. This enables each service provider to access only the data that is relevant to the provided services. More particularly, in some embodiments of the invention the managing system 224 is provided as an integration point to a service provider's Operational Support Systems (“OSS”). OSS is software that helps a communications service provider monitor, control, analyze, and manage problems with a telephone or computer network. In the present case, the OSS serves to track and manage problems and coordinate repairs and upgrades. It also allows communications service provider to anticipate the reason for customer service calls and response appropriately.

In addition to collecting information that tests and/or monitors a user experience from the user's perspective, the information collected by the agents can also be used for marketing purposes. A user that places high demand on bandwidth, for example, may be offered a different service based on their use of the network.

Referring now to FIG. 3, one embodiment of receiving server 220 is depicted in greater detail. Data collected from connectivity devices, including both low level metrics and high level metrics, is received and stored in data storage 302. Data storage 302 is a storage medium configured to receive and store received data, such as SMTP messages, until it is needed. Receiving server 220 also preferably includes, or includes access to, a user interface 304. User interface 304 allows an administrator to configure rules, specify metrics of interest, and otherwise customize an analysis to obtain data and results of interest.

Expert engine 306 is preferably a computer application that performs predictive analysis tasks. More particularly, expert engine 306 is used to analyze data from data storage 302 in view of the rules and other customizations that may be received from interface 304 to determine high level metrics such as results, scoring, and other information to provide the predictive analysis. The predictive analysis allows an administrator to identify the level of a user's likely service satisfaction or quality of experience and to identify any problems and their likely sources. The output from the expert engine 306 can then be used predict and prevent sources of problems for the end users and improve customer satisfaction. For example, the expert engine 306 can be configured to provide an overall quality of experience score that a non-technical person could review to understand the quality of services provided to a user with a particular device at a particular location. A quality of experience score could also be used in an automated process to render alerts or provide recommendations for system upgrades in certain areas or advertise additional services to a user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a communications network in which a service is provided to a plurality of users, a method for testing the quality of service provided to a user, the method comprising:
providing an agent on a connectivity device of a user;
causing the agent to perform one or more tests involving the connectivity between a network device and the connectivity device;
collecting data from the one or more tests, wherein the data is indicative of an aspect of a user experience; and
transmitting the collected data to a receiving server using at least one scalable protocol.

2. A method as define in claim 1, further comprising the act of transmitting to the connectivity device a profile for use by the agent, wherein the profile comprises one or more tests to be performed by the agent.

3. A method as define in claim 1, further comprising the act of causing the agent to generate from the test data a high level metric indicative of a predicted user quality of experience.

4. A method as define in claim 1, wherein the one or more tests are performed when the connectivity device is not being used by a user.

5. A method as define in claim 1, wherein the one or more tests involve establishing a communications link between the connectivity device and the network device and simulating a user action on the communication link.

6. A method as define in claim 1, wherein the connectivity device comprises a cellular telephone, a set-top box, a modem, a VoIP phone, a wirelessly connected computer, or a computer.

7. A method as define in claim 1, further comprising, at the receiving server, an act of processing a plurality of collected data with an expert engine to determine a high level metric indicative of a predicted user quality of experience.

8. A method as define in claim 1, wherein the scalable protocol comprises SMTP.

9. A system for testing the services provided to an end-user by a service provider in a communications network, comprising:
a testing agent embedded within a connectivity device associated with a user, wherein the connectivity device is in communication with a network and the testing agent performs one or more tests in order to simulate a user's activities and obtain data regarding the simulated activities; and
a receiving server in communication with the network, the receiving server comprising a data storage device configured for receiving and storing test data from the testing agent.

10. A method as define in claim 9, wherein the test data is sent from the testing agent to the receiving server as an SMTP packet.

11. A system as defined in claim 9, wherein the network is administered by a service provider that provides communication services to the connectivity device.

12. A system as defined in claim 9, wherein the receiving server further comprises an expert engine configured for analyzing the test data and providing a predictive analysis.

13. A method as define in claim 9, wherein the test data comprise low level metrics representing specific test results and the testing agent further comprises an expert module that generates, using a plurality of low level metrics, a high level metric indicative of a predicted user quality of experience.

14. A system as defined in claim 9, wherein the receiving server further comprises a user interface for receiving user input to provide analysis controls to the expert engine.

15. A system as defined in claim 9, wherein the testing agent can receive, via the network, profiles having one or more tests to be performed by the testing agent.

16. A system as defined in claim 9, wherein the testing agent performs one or more tests in order to simulate a user's activities by proactively consuming and measuring the end-to-end performance of services provided by the service provider.

17. A system as defined in claim 9, wherein the connectivity device comprises a cellular telephone and the network is administered by a cellular telephone service provider.

18. A system as defined in claim 9, wherein the connectivity device comprises at least one of a set-top box, a modem, a VoIP phone, a wirelessly connected computer, or a computer.

19. A system as defined in claim 9, wherein the one or more tests are performed when the connectivity device is not being used by a user.

20. A method as define in claim 9, wherein the simulated activities comprise the operation of an application on the connectivity device.

21. A system for testing the services provided to an end-user by a service provider in a communications network, comprising:
a testing agent embedded within a connectivity device associated with a user, wherein the connectivity device is in communication with a network and the testing agent performs one or more tests in order to simulate a user's activities by proactively consuming and measuring the end-to-end performance of services provided by a service provider; and
a receiving server in communication with the network, the receiving server comprising:
a data storage device configured for receiving and storing test data from the testing agent; and
an expert engine configured for analyzing the test data and providing a predictive analysis.

22. A method as define in claim 21, wherein the test data comprise low level metrics representing specific test results and high level metrics indicative of a predicted user quality of experience, wherein the testing agent further comprises an expert module that generates, using a plurality of low level metrics determined from at least one of the one or more tests, a high level metric.

23. A system as defined in claim 21, wherein the receiving server further comprises a user interface for receiving user input to provide analysis controls to the expert engine.

24. A system as defined in claim 21, wherein the testing agent can receive, via the network, profiles having one or more tests to be performed by the testing agent.

25. A system as defined in claim 21, wherein the connectivity device comprises a cellular telephone and the network is administered by a cellular telephone service provider.

26. A system as defined in claim 21, wherein the connectivity device comprises at least one of a set-top box, a modem, a VoIP phone, a wirelessly connected computer, or a computer.

27. A method as define in claim 21, wherein the test data is sent from the testing agent to the receiving server as an SMTP packet.

28. A system as defined in claim 21, wherein the network is administered by the service provider.
